(19) United States
(12) Patent Application Publication
(10) Pub. No.: US 2011/0011795 A1
(43) Pub. Date: Jan. 20, 2011

(54) Fluid pressure driven centrifuge apparatus

(76) Inventor: William D. Hoff, Rochester, MI (US)

Correspondence Address: WILLIAM W. HAEFLIGER, 201 S. LAKE AVE, SUITE 512, PASADENA, CA, 91101, US

(21) Appl. No.: 12/460,085

(22) Filed: Jul. 15, 2009

(51) Int. Cl. B01D 21/26

(52) U.S. Cl. 210/512.1

(57) ABSTRACT

A centrifuge, comprising an upright shaft, defining an axis, a fluid centrifuging chamber rotatable about the shaft axis, first porting extending endwise in the shaft and opening laterally to said chamber, to deliver fluid to be centrifuged, to the chamber, a structure in the chamber and into which contaminate in the fluid is centrifuged for separation from the fluid, during chamber high speed rotation, a rotor supporting the chamber for rotation about the axis, the rotor rotating with the chamber, there being at least one fluid outlet to jet fluid discharged from the rotor, and passage structure for delivering fluid that has been jetted via the fluid outlet.

### BACKGROUND OF THE INVENTION

This invention relates generally to centrifuging of fluids to separate solid contaminate from such fluids; and more particularly concerns highly effective and efficient centrifuging apparatus operating at very high rates of rotation, and methods of operation.

There is continual need for more efficient compact, reliable, simple and effective centrifuging equipment, and capable of removing micron size particulate from fluids, such as engine fuel and hydraulic fluids. The present invention provides apparatus and methods that meet such needs. The disclosure of U.S. Pat. No. 6,294,091 is incorporated herein by reference.

### SUMMARY OF THE INVENTION

It is a major object of the invention to provide improved centrifuging apparatus that comprises, in combination:

a) an upright shaft, defining an axis,

b) a fluid centrifuging chamber rotatable about the shaft axis,

c) first porting extending endwise in the shaft and opening laterally to said chamber, to deliver fluid to be centrifuged, to the chamber,

d) a matrix in the chamber and into which contaminate in the fluid is centrifuged for separation from the fluid, during chamber high-speed rotation, and

e) a rotor supporting said chamber for rotation about said axis, said rotor rotating with said chamber, there being at least one fluid outlet to jet fluid being discharged from the rotor.

A further object includes providing a tubular member extending about the shaft and operatively connected to the centrifuging chamber and the rotor, and further providing a high speed bearing located between a mid-portion of the shaft and said tubular member, but above the level of the fluid jet outlet or outlets via which torque is applied to the rotor. As will appear, the tubular member typically extends downwardly and outwardly from the bearing and about two jet outlets at opposite sides of the central axis defined by the shaft, providing a highly compact, efficient assembly.

Yet another object is to provide a series of axially spaced of axially spaced, generally radially extending passages with said matrix located therein in the centrifuge chamber configured to generally radially conduct inward and outward sequential flows of the fluid, the passages in series communication, whereby fluid discharges from one of the passages for flow to the outlet or outlets below the passages.

A further object includes provision of the fluid jetting outlets spaced closely below said passages, and bearing, and at opposite sides of an axis defined by the shaft, to produce torque for rotating the rotor and chamber.

An added object is to provide a support body supporting the shaft, and forming a sub-chamber within which the rotor rotates, the sub-chamber defining jet deflectors toward which fluid is jetted from the outlet or outlets.

A circular series of such deflectors may be provided on the support body in the paths of high-speed fluid jets discharged at the rotor outlets, as referred to above, to enhance torque development, in the highly compact assembly.

These and other objects and advantages of the invention, as well as the details of an illustrative embodiment, will be more fully understood from the following specification and drawings, in which:

### DRAWING DESCRIPTION

FIG. 1 is a schematic representation of a fluid driven centrifuging filter system, in a preferred form;

FIG. 2 is an enlarged diagrammatic showing jetted fluid reaction against booster surfaces;

FIG. 3 is a schematic top plan view of fluid flow relative to the booster surfaces;

FIG. 4 is a section taken through a high-speed radial bearing;

FIG. 5 is a plan view of needle bearings that absorb shaft axial loading;

FIG. 6 is a section taken through a needle bearing;

FIG. 7 is an enlarged section taken at the shaft lower end and showing radial needle bearing locations;

FIG. 8 is an enlarged section taken at the shaft upper end, and showing radial and needle bearing locations;

FIG. 9 is a view like FIG. 1, and showing a modified centrifuge assembly; and

FIG. 10 is a perspective view showing a centrifuge mounting bracket attachable to support structure.

### DETAILED DESCRIPTION

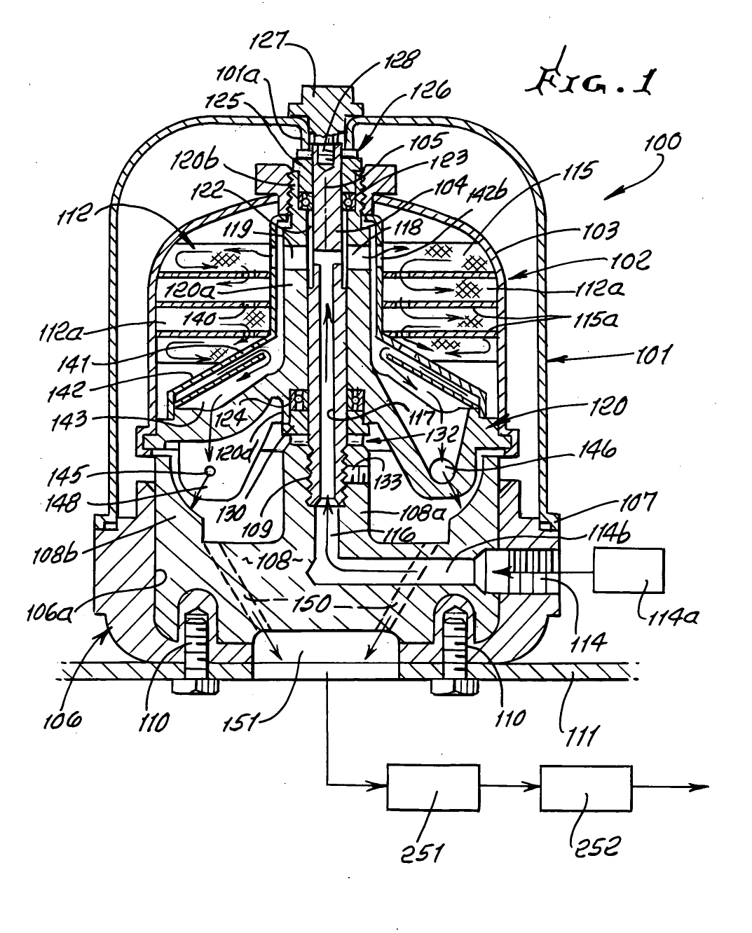

FIG. 1 shows a fluid filtering assembly 100 including an outer dome shaped housing 101; a rotary chamber 102 including an inner dome shaped housing 103; and an non-rotating central upright shaft 104 defining a central axis 105. A cup-shaped outer support body 106 supports housing 101 at annular location 107; and an inner support body 108 has a centrally located upright abutment or protrusion 108a rigidly supporting the shaft 104, as at threading 109. An annular flange 108b defined by body 108 is received downwardly in outer support bore 106a. Connectors, such as bolts 110 connect 106 to support structure 111.

Also provided is a matrix 112 in the rotary chamber 102, and into which contaminant such as particles in the fluid is centrifuged for separation form the fluid, during chamber high-speed rotation. Contaminated fluid is communicated to the matrix material, as from a host reservoir 114a, via inlet 114 to lateral passage 115, upright passage 116, in 108, and via central bore 117 in the shaft 104. Fluid then flows via lateral passages 118 in 104 and 119 in a rotor 120 that supports the chamber 102 to the matrix and vertically spaced sub-matrices 112a that are in series communication, as shown, there being passages 115 that contain the sub-matrices.

Rotor 120 includes an upper tubular stem portion 120a closely surrounding the shaft and that forms radial passages 119 registering with the radial passages 118, there being annular fluid receiving space or zone 122 between 118 and 119 to collect and assist fluid flow during high speed rotation of 120.

Upper and lower roller bearings 123 and 124 position the rotor 120 for high-speed rotation about the shaft 104. An upper bushing 125 projects between the upper end 120b of 120, and the shaft 104, to retain roller (ball) bearing 123 in position; and radially extending needle bearings at 126 provide a thrust bearing between the top of the rotating bushing and a non-rotating turned-down end 101a of outer housing 101. The latter is held in position by a nut 127 that is thread connected at 128 to the shaft upper end.

A lower bushing 130 projects between a lower end annular portion 120d of 120, and the shaft 104, to retain roller (ball) bearing unit 124 in position; and radially extending needle bearings at 132 provide thrust bearing positioning between the bottom of the rotating bushing, and the top of the non-rotating protrusion 108a. Note the threaded locking insert 133 in 108a, projecting into the threaded connection 109, locking the shaft against loosening from the connection to 118a.

Suitable matrix material typically fills the radially extending annular passages 115, but the passages may be open to assist fluid flow, as shown. The passages are separated by radial walls 115a. The latter are separated by radial walls 115a, which define through openings 140 allowing fluid to flow successively through the passages, as shown by the flow path arrows, during centrifuging of the fluid, separating it from more dense particulate forced radially outwardly by centrifugal forces, and collected. Collection zones are provided in passages 115 between openings 140 and the wall of 102. The filtered fluid flows downwardly via such openings and passes through openings 141 in an annular thin walled separator 142 having inverted funnel shape, as shown, and which rotates with 120. Openings 142b in 142 pass fluid from 119 to passages 115. That separator assists in supporting the radially inward ends of radial walls 115a. The fluid is subsequently received in zone 143 below 142, and passes downwardly to outlets 145 and 146 facing in opposite directions. Those outlets form small diameter openings for jetting the pressurized fluid in opposite directions, generally normal to the plane of FIG. 1, creating torque for effecting high speed (over 5000 RPM) rotation of 120 and the centrifuging chamber and passages. Jetted fluid collects in annular zone 148 formed by 108, for subsequent flow at 150 toward a fluid out port 151. Mist from the jetted fluid accesses and lubricates at least the lower bearings. From port 151, fluid may be suctioned to a pump such as gear pump 251, for delivery to system components 252, or return to 114a.

As also shown in FIG. 2, the jetted fluid at 152 impinges against angled surfaces or plates 153 arranged annularly about the shaft axis 105, in such manner that some reaction force is produced to aid in spin torque application to the rotor 120.

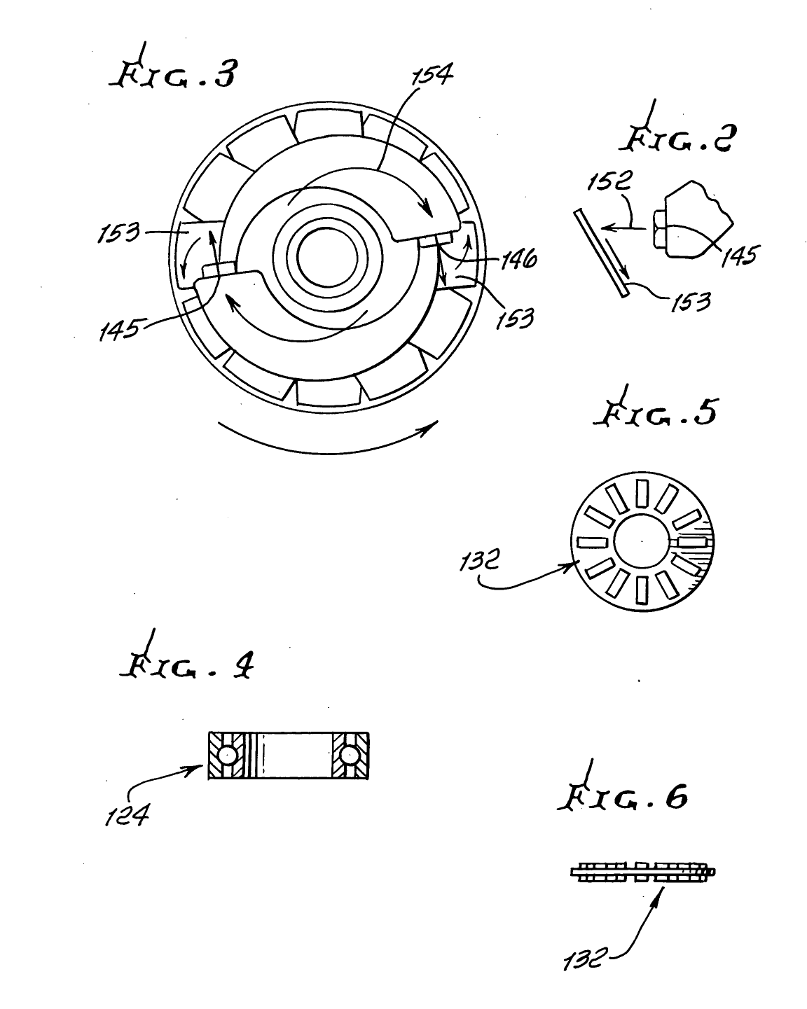

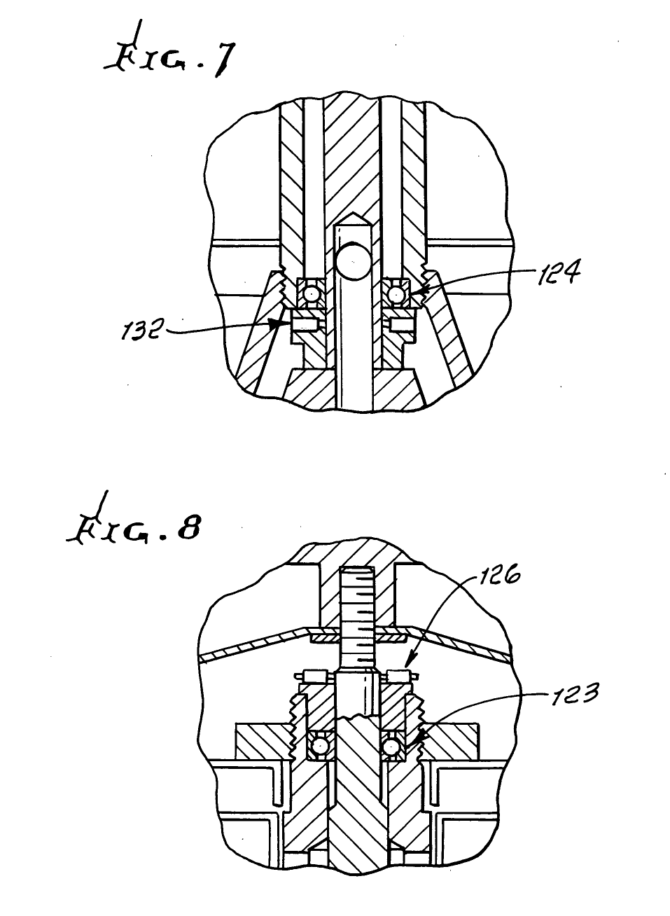

In FIG. 3, arrows 154 indicate the curved paths of fluid, such as oil, forced downward through the filtering matrix, for jetting at 145 and 146. Reaction surfaces or plates appear at 153, as in FIG. 2. FIG. 4 shows a typical high-speed roller bearing, as at 124; and needle bearings as at 132 and 126 appear in FIGS. 5 and 6.

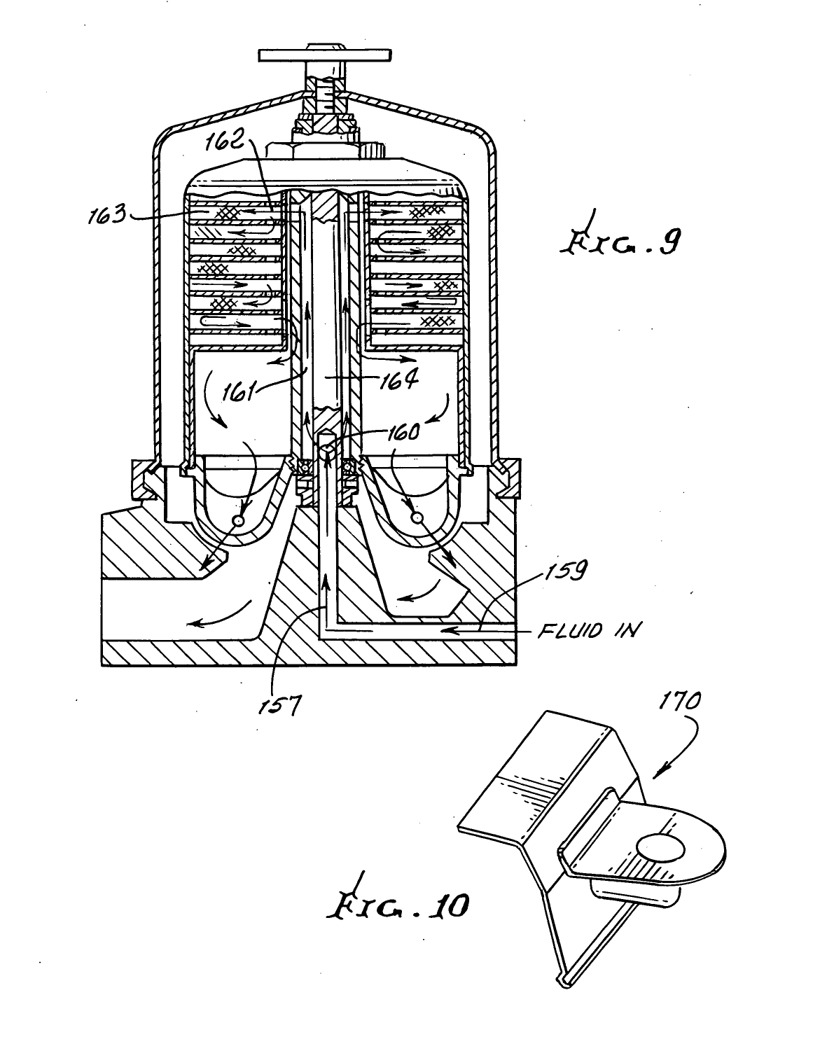

FIG. 7 illustrates a typical bearing 124 and 132 installation; and FIG. 8 illustrates a typical bearing 123 and 126 installation.

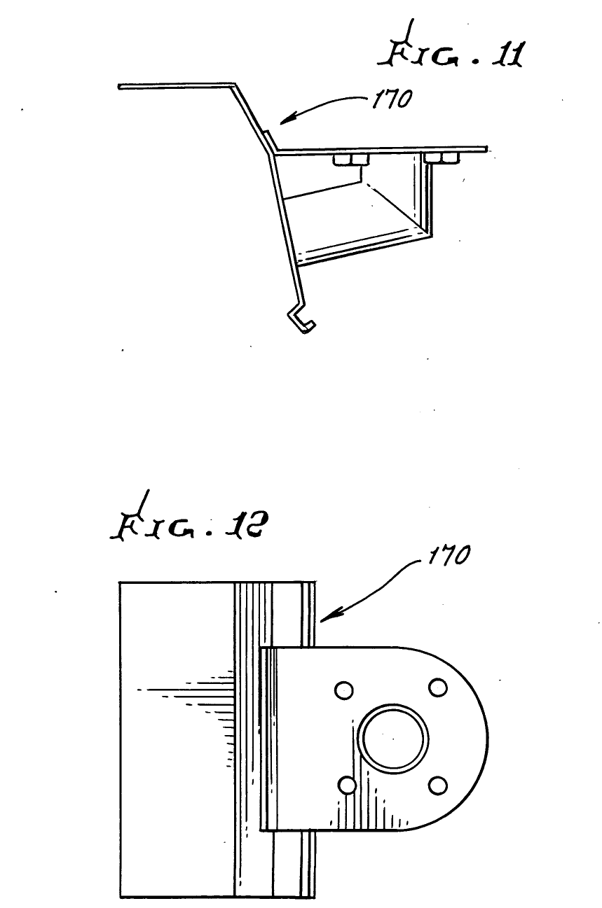

FIG. 9 is like FIG. 1, but illustrates a somewhat modified form of the apparatus. Inlet flow 159 separates at 160 to flow upwardly in a passage or passages 161 at the outer side of the shaft 164 for delivery at 162 to the centrifuging passages 163, like those described in FIG. 1. The rotor 164 corresponds to rotor 120. Other corresponding elements bear the same identification numerals.

FIGS. 10-14 show various views of support brackets 170 and 171, for the centrifuging apparatus, as for example to support base 106, via connectors 110.

Advantages of the invention, and claimed improved results:
1) Removes particle contaminants from very large sized solid particulate down to as low as a tenth of a micron in size and less. Solid particulates, if not removed, cause wear and impair functions of close tolerance components in any lubrication system.
2) Removes degradated oil (coked or burnt) contaminant sludge which otherwise causes changes in viscosity of the fluid as well as coked oil which may develop into an abrasive cinder-like contaminant.
3) Insures reliable operations of and increases overall engine, transmission, and hydraulic system efficiencies, by elimination of contaminants and sludge.
4) Reduces lubrication system operating temperatures by removing wear-metal and other friction causing contamination, and thereby increases over all film-strength of the lubrication oil/fluid. For example, engine oil analysis test conducted show removal of iron wear metals down to as low as “2 ppm”, and “0 ppm”. Reduction in wear metals reduces the friction within the oil to the point where current overall engine oil operating temperatures are reduced by as much as 30 to 60 percent (depending upon moderate to adverse driving conditions and loads).
5) Provides increased engine horsepower due to overall cooler operating engine temperatures.
6) Reduced engine oil temperature is achieved by the following:
   i. Removal of heat causing friction wear metals (oil analysis test show just over a 97% reduction in parts per million (ppm) of iron wear metal, and 100% reduction in all other engine wear metals)
   ii. Removal of heat-holding heavy carbon particles and degradated oil or grease
   iii. Items i. and ii above allow the oil or lubrication fluid to become less saturated with heat retaining contaminants and in turn the host fluid becomes “more wet” (not moisture related) therefore becoming less saturated with solids allowing for optimum heat exchange/transfer capability to occur from the engine or host equipment to the oil/fluid, than from the oil/fluid to the on-board or existing cooling system; on a continual cycle.
   iv. It will be noted that engine oil molecules and their additives breakdown or degrade under exposure to heat between and exceeding 140 to 150 degrees Fahrenheit. Another attribute is that the oil cleanliness levels achieved have allowed current diesel engine oil operating temperature test results not to exceed 126 degrees Fahrenheit. Therefore, in this case, the oil molecule and their additives degradation heat threshold/limit is never exceeded. Current independent oil analyses demonstrate that the diesel engine oil's additive package, oil viscosity and lubricity preserved.
   v. Acid is another cause for oil molecules and oil additives breakdown. The present oil-driven centrifuge configuration for example, removes carbon which is part of an acidic compound. Additionally, moisture is another element in acid formation. The present oil driven centrifuge removes over 99.9% of moisture (free water and dissolved water) from the engine oil crankcase. The effective moisture removal from the engine oil causes the crankcase to be free from 99.9% of moisture, also evident in assisting the lowering of emissions' moisture levels (CO2) in combustion processes regarded as being directly correlated.
   vi. Additionally, a particle analysis actually performed without dilution demonstrates a 22/19/11 ISO cleanliness code. Particle analyses are generally only performed on hydraulic oil, but rarely on engine oil (unless the engine oil comes directly out of a new bottle) since engine oil's standard carbon contamination saturation and soot index is usually much higher, which usually blocks particle analyzers from counting.
   vii. Oil additives remain preserved for longer periods of time for the life of the oil and possibly the host machinery.
7) Extends host machinery, seals, and other components life expectancy. Achieves reductions in engine, transmission, and brake/steering hydraulic system maintenance and repair costs, and increases life-span of machinery components by reducing wear rates up to 97% or higher. Old seals and new seals alike also remain preserved.
8) Achieves reduced equipment down time and reduced major engine and transmission repair/overhaul.
9) Maintains dimensional consistencies of moving parts due to reduced wear. Note: In standard diesel engines with standard oil filtration, contamination build-up will form behind piston rings, eventually pushing the rings outward, causing scoring and direct wear of the cylinder walls. Cylinders with heavy wear usually form a tapering wear pattern along the cylinder walls due to the sticky, seized or permanently stuck or pushed out rings. The taper in the cylinders will create a space between the piston ring and the cylinder which dramatically increases the rate of blow-by or engine emissions, due to reduced cylinder compression ratios in significant proportions. When compression is reduced, increased amounts of hydrocarbons or unburned fuel become present in the firing or combustion chamber. Piston rings are designed to create a seal between the piston and cylinder. Piston rings are also designed to actuate along the cylinder wall, but when heavy contamination is present, this limits the actuating function of the piston ring itself. With use of the present centrifuge, contamination build-up is reduced and eventually totally removed over a relatively short period of time (depending upon the age and current wear of an engine prior to installation) allowing the piston rings to seal and actuate more effectively, as designed to perform. The cleaner and cooler operating engine oil is characterized by increased oil film-strength, which maximizing the seals between the piston rings and cylinder walls, and therefore enables increased compression ratios for more complete burn of fuel. Current test results demonstrate visibly no PM (particle matter), nor blow-by, and zero “0” HC's (hydrocarbons—unburned fuel), and zero “0” NO's (nitrous oxides).
10) Reduces EPA mandated hazardous waste-oil handling and disposal costs and liabilities by allowing the oil to remain in use for longer periods, possibly for the lifetime of the equipment/vehicle/or vessel.
11) Reduces Nitrous Oxides (NO's), Hydrocarbons (HC's) and CO₂ emissions levels down to, and even less than, current and future EPA mandated Emission requirements, as specified for years 2010 through 2012. This is due to the extreme clean and cooler centrifuged oil retaining higher film strengths between cylinder and piston moving parts, with highest possible lubricity between the piston rings and cylinder walls, thereby increasing the engine's overall compression ratio, and thereby causing a more complete burn of the fuel in the combustion chamber.
12) Due to the related benefits as listed above achieved by the invention, a final observation and continued test have been performed in regards to increased fuel economy. Prior to installation of the present unique centrifuge system, the diesel test vehicle (which began testing at over 218,000 miles) was only capable of reaching approximately 11.4 MPG City, and 14.3 GPM Highway. After installation of the present oil-driven centrifuge system, the test vehicle was put through a little over 5,000 mile test run. During this test run, the fuel economy gradually increased, and towards the first 5,000 mile marker this particular test vehicle increased its city and highway fuel economy by up to 36%.
13) Reduces replacement oil costs by increasing useable oil lifespan, potentially even to the lifetime of the equipment. System viability tested and documented in on-line use for diesel engine application. Additional independent on-line testing and documentation to continue.

Process and System Description:

The described Oil-Driven Centrifuge, Oil/Fluid Cleaning Unit, is intended for use for by-pass mount configurations (and can be configured for full-flow) on trucks, automotive, or vessels for the purpose of continually cleaning the lubrication oil system in the host machine (engine, transmission, hydraulic, and etc).

The system is comprised of a number of internal components which produce a remarkable level of oil cleanliness in engine, transmission, and hydraulic oils/fluids.

System safeguards can be incorporated into the system (as accessories) by using a low-voltage pressure sensor switch. This switch serves to interrupt power to a servo-valve, and when the centrifuge reaches maximum contaminant holding capacity, a light illuminates on the dash of the operators vehicle or vessel to signal that centrifuge cartridge replacement is necessary.

Process:

The pressurized fluid from the host equipment or engine sends pressurized oil to the inlet port of the centrifuge. Second, the pressurized oil flows up the stationary shaft and out two ports (facing east and west) at the top of the stationary fixed shaft. The rotating centrifuge cartridge shaft provides two or more oil/fluid receiving inlet ports to the centrifuge cartridge, which receives the oil from the stationary fixed shaft. The pressurized oil/fluid is then forced into the high-speed, high RPM rotating centrifuge cartridge through a complex maze of specially designed internal media.
The design of the centrifuge cartridge permits oil/fluid flow to be forced through a series of multiple high-heat, non-corrosive, high-RPM filter media either disc-shaped (donut-shaped), cylindrical-shaped (vertically placed), or sectional, with insert media levels placed either vertically or horizontally (depending upon any variation thereof) which are stacked layers (either one on top of another or side-by-side (each layer encompasses variations in regards to its make-up, thickness, height, length, width, or diameter). The filter media make up is typically comprised of one or more of the following (cotton, cotton cloth, paper media (treated and/or untreated), or any other media variation thereof resembling the coarseness or compressed porosity of the above listed examples. Each section of filter media is divided by a thin separating plate or disc (of any high-heat resistant lightweight material).
   The very thin, separating dividing plates/discs are comprised of non-corrosive, lightweight, high-heat resistant Teflon (or materials with similar properties), or non-corrosive, lightweight, high-heat resistant metallic material (such as tin or any other lightweight metals with similar properties). Each separating dividing plate/disc provides 2, 3, or 4 through holes, about 1/16 inch or ⅛ inch in diameter or any variation thereof regarding their size in diameter, lesser or greater. Holes or oil passageways within each disc are typically placed through the disc by and around the edge, nearest the inner diameter of the disc with out exceeding the edge of the inner diameter of the separating dividing plate/disc.
   The filter media discs as well as the separating plates/discs are provided as one unit with the entire rotating centrifuge cartridge, wherein the inner material is fixed to the inner drum of the rotating centrifuge cartridge as well as fixed to the outer diameter of the rotating part of the rotating centrifuge cartridge. The drum, inner media filtering levels, separating dividing plates/discs/horizontal or vertical sections (depending upon which configuration), shaft, base, drum housing, orifices/outlet ports (oil jets—jet port size and number of jets in the base of the cartridge are typically provided in any variation of sizes and or number of jets), two (2) high-speed ball bearings, and two (2) high-speed needle bearing thrust washers comprising the whole of the rotating centrifuge cartridge as one unit.
   The filter media discs or vertical sections as well as the separating plates/discs can also be provided as separate inner cartridge “inserts” to allow reuse of the main rotating centrifuge cartridge drum and rotating cartridge shaft component(s).
      Note: In today's market, engine oils are now specifically engineered to reduce the chance of engine oil contamination settling or buildup, sometimes marketed as “sludge protection” oil additive formulas. The oils include additives which serve as a dispersant and suspension agent. The centrifuge described herein is typically able to momentarily and deliberately disturb the dispersant/suspension agent additive bond with the present oil contamination; i.e. only momentarily at the point of the centrifuge.
   Each level within the rotating centrifuge cartridge operates by the same means, except that each level becomes less porous than the previous level before it, as the oil is being forced to enter through and across the media. The other variation is that each level of media can be rated for similar porosity, and makeup can be for the same media material all the way through.
   As soon as the pressurized oil reaches the rotating centrifuge cartridge, it pressurizes the latter, full of oil/fluid. The pressurized oil flow along with the introduction of the G-Forces generated by the RPM of the rotating centrifuge cartridge first forces the oil flow in a horizontal outward radial direction across the filter media (causing a “scrubbing action” to momentarily disturb the bond between the oil's contaminants and the oil itself, to allow optimum separation between the contamination, solid particulates, and the oil. Second, the pressurized oil is then forced to flow in reverse direction back towards the center of the centrifuge along a path of least resistance along and between the edge of the filter media and the top surface of the separating plate/disc/or sectional divider. Next, the oil is forced to enter into the next level by exiting the upper level through the channel or hole of the separating plate/disc/section located just beneath the filter media and nearest the rotating centrifuge cartridge shaft.
   Variations include different placements of internal parts and media or rerouting of oil flow; such as media and separating divider plates/sections as noted above being placed and stacked in a different position; either a vertical or horizontal position and/or combination of both, or as a vertical cylindrical way in the shape of or not in the shape of the rotating centrifuge cartridge. Note: The design of the media layers and dividing sections as being stacked side-by-side wherein the oil pressure and oil flow forces the oil “north and south”, directly perpendicular to the centrifuge G-Forces, is not preferred since it could run a risk of constant exposure for the shearing effect to occur to the oil molecules (causing smaller and smaller oil molecules to form or possibly even resulting in oil degradation) by means of outward centrifugal force being applied at a constant rate to the “north and south” directions of the pressurized oil flow.
   The unique centrifuge is provided with three installation options. First, the centrifuge can be installed directly onto a valve-cover/bracket assembly (varies between types and sizes of engines). Plumbing (oil-flow conduit) accessories are required to plumb from the oil sending unit of the vehicle to the centrifuge. The centrifuged clean oil then drains from the centrifuge down into the valve cover. This first installation option allows for a complete removal of old i.e. existent valve cover and replacement with above referenced custom valve cover/bracket assembly. Next option for installation is to mount the centrifuge above the level of the oil sump/reservoir, and to plumb pressurized oil to the centrifuge. Third option for installation is for end user to take existent valve cover off and modify structure in order to mount the centrifuge to it. Or and last option, mount centrifuge anywhere on vehicle, plumb to centrifuge from any oil pressure source, and plumb the outlet straight down to the return sump/reservoir.

The unique centrifuge unit demonstrably achieves RPM levels and G-Forces that far exceed those of any other hydraulically-driven bypass filtration system currently on the market.

Note: Other oil driven centrifuges on the market lose there oil cleaning efficiency due to 1) adverse driving or rough road surface conditions, 2) vehicle exceeding minimal or steep grades, which subjects the centrifuges to disadvantages of exceeding their operating limitations of +/−10 degrees from vertical mount position.
1.a) Under adverse driving or rough road conditions, standard centrifuges on the market become jarred because of the shock and metal to metal contact between the rotating bushing around the stationary shaft, and then gyration, slowing of the RPMs, and even total stoppage of the rotating device. Constant G-Forces are needed to hold contamination in place within the inner walls of these standard hydraulic centrifuges. When any kind of significant shock occurs, the G-forces drop off significantly or totally, and finally, this results in constant oil pressure from the engine to flush out the entire centrifuges, holding contaminants back into the entire lubrication system.
2.a) Lastly the main reason such standard hydraulically driven centrifuges cannot perform in moderate or steep grade driving conditions is because after 10 degrees tilt from vertical mount position, the oil exiting the oil jets fills up the cavity where the jetted oil needs to hit a solid surface in order to cause propulsion. Jetted oil hitting oil reduces the propulsion factor significantly and will cause the flooded oil to create surface friction between the rotating turbine and the oil itself.

This flooding causes the centrifuge to flush out its contaminant contents, once again.

Some centrifuges on the market use a different configuration wherein a portion of the contaminated engine oil pressure is fed directly into a small orifice which drives rotating turbine blades connected to a rotating shaft which drives the centrifuge. The first problem is that they still implement use of bushings to shaft configuration which causes problems as mentioned above. Secondly, the shooting of dirty oil into the cavity where the driving mechanism of the centrifuge is rotating is a huge problem; not only will dirty oil cause premature life in the seals, but leaks, occur. Thirdly, and according to oil engineers, if a process pressurizes contaminated oil volume through a small orifice, then friction occurs right at the point of the orifice and coking of the oil will occur. Coked oil is very abrasive. Fourth, this will cause the orifice or jet to close up over time, much like a clogged artery.
Finally, and internally, standard centrifuge drums are generally empty, and nothing holds contaminants back incase G-Forces drop off under moderate to extreme driving and road conditions.

In applicant's centrifuge configuration, flooding cannot occur because constant propulsion is achieved and high-speed ball bearings are placed around the vertical wall of the shaft of the rotating centrifuge cartridge on both ends of the cartridge (upper and lower ends). The high-speed ball bearings are implemented in the unique oil-driven design to serve the purpose to resist side loading from moderate to adverse driving and rough road environment conditions. The outer races of the high-speed ball bearings, are typically fixed to the rotating structure of the rotating centrifuge cartridge. The entire rotating centrifuge cartridge is removable and replaceable or reusable. The rotating centrifuge cartridge slides onto a stationary fixed (non-rotating) shaft which extends upward from stationary centrifuge housing base. It is important to note that the inner races of the high-speed ball bearings are not fixed to any shaft. Under adverse mobile, driving, rough-road conditions, where side-loading constantly occurs between a fixed shaft and rotating shaft, only then do the inner races of the high-speed ball bearings technically become an active fixed part to the fixed shaft whereby the bearing inner races only intermittently establish contact with the fixed shaft in order to significantly reduce side loading forces between the two shafts to a minimum, if not, completely.

Free floating needle bearing thrust washers on both top and bottom ends of the rotating centrifuge cartridge shaft are included to reduce friction as well as reduce upward and downward loading forces between the top of the rotating centrifuge cartridge shaft and the underneath inside surface where the fixed housing connects to the fixed shaft.

The combination of 1) constant oil/fluid pressure 2) hitting specially designed fixed fins/blades for increased propulsion from the oil exiting the jets, 3) along with high-speed ball bearings and needle bearing thrust washers “load-resisting” design, facilitates optimization of RPM's, G-Forces, and constant acceleration of the rotating centrifuge cartridge even under the most adverse driving and road conditions (including severe angles of operation between vertical or horizontal plane) to which an operator is willing to subject their vehicle to.

Additional Features:

This primary multi-layer centrifuge separator chamber is fitted with a disposable high-speed filtration medium that assists in breaking even sub-micron contaminants loose from the fluid, as well as affecting oil-water separation.

The first stage of the separator can be fitted with multiple layers of the filter medium, segmented with discs to provide additional agitation of the fluid, again assisting in the contaminant removal.

The fluid then passes though into the lower secondary separator chamber, causing another turbulent action to occur that further enhances the separation process.

This multi-layer, multi chamber application achieves the effect of passing the fluid through a series of linked in-line centrifuges, but concentrated into only one centrifuge.

The clean fluid exits the rotating centrifuge cartridge through directional jets, which in turn drive the turbine, and further propulsion is created due to the pressurized exiting clean oil striking multiple fixed or stationary blades/fins.

The fluid ejected through the jets engages a set of angled vanes, of a laser-cut and formed plate configuration, with soldered tubular legs, that are screw mounted within the bottom of the well of the centrifuge base casting. Another version is equipped with vanes that are integrally cast with the centrifuge base casting itself. Both versions function equally well. This vane assembly (or casting) configuration serves two functions. The first is to reduce air entrainment into the jets which would reduce the thrust and hence speed of the spinning drum. The second function is to direct the jets tangentially to the drum, thereby increasing the RPM of the turbine drum assembly aka (rotating centrifuge cartridge). Higher rotational speed translates to higher “G-forces”, and hence increased contaminant separation ability. To protect the centrifuge, its components, as well as the engine/equipment, incase the centrifuge exceeds its holding capacity, the centrifuge is equipped with a bypass valve mounted into a threaded port in the front of the centrifuge base casting. The fluid then exits the centrifuge through a larger port on the opposite side of the centrifuge base casting from the inlet port.

I claim:

1. A centrifuge, comprising
a) an upright shaft, defining an axis,
b) a fluid centrifuging chamber rotatable about the shaft axis,
c) first porting extending endwise in the shaft and opening laterally to said chamber, to deliver fluid to be centrifuged, to the chamber,
d) structure in the chamber and into which contaminate in the fluid is centrifuged for separation from the fluid, during chamber high-speed rotation,
e) a rotor supporting said chamber for rotation about said axis, said rotor rotating with said chamber, there being at least one fluid outlet to jet fluid discharged from the rotor, and produce torque acting to rotate the chamber, and
f) passage structure for delivering fluid that jets via said fluid outlet.

2. The combination of claim 1 including a non-rotating housing receiving said chamber and said shaft.

3. The combination of claim 1 including a tubular member extending about the shaft and operatively connected to the centrifuging chamber and the rotor.

4. The combination of claim 3 including a high-speed bearing located between a mid-portion of the shaft and said tubular member, but above the level of the fluid jet outlet or outlets via which torque is applied to the rotor.

5. The combination of claim 4 wherein said tubular member diverges downwardly about the bearing, to form the rotor.

6. The combination of claim 3 including a housing extending about the centrifuging chamber, said tubular member having a flange supporting said housing.

7. The combination of claim 6 including a series of axially spaced, generally radially extending passages with said structure therein located in the centrifuge chamber configured to conduct generally radially inward and outward sequential flows of the fluid, the passage in series communication, whereby fluid discharges from the passages for flow to the outlet or outlets below the passages.

8. The combination of claim 7 wherein the rotor extends directly below said passages.

9. The combination of claim 8 wherein there are two outlets spaced closely below said passages, and bearing, and at opposite sides of an axis defined by the shaft.

10. The combination of claim 9 including a support body supporting the shaft, and forming a sub-chamber within which the rotor rotates, the sub-chamber defining fluid deflectors toward which fluid is jetted from the outlet or outlets.

11. The combination of claim 1 including thrust absorbing needle bearings at an upper location above the shaft to receive axially directed thrust loading exerted by the shaft, in response to fluid pressure exerted axially within the shaft.

12. The combination of claim 7 wherein the lowermost of said passages flares downwardly and outwardly to act as a flow confining guide for fluid flowing downwardly toward said outlet or outlets, said lowermost passage also acting as a particulate collector for centrifuged particulate, there being two of said outlets at opposite sides of an axis defined by the shaft, and angled for jetting fluid in directions to develop reaction torque transmitted to the tubular member and passages.

13. The combination of claim 3 including a separator having inverted funnel shape extending between said member and said structure, to rotate therewith.

14. The combination of claim 4 wherein said at least one outlet to which centrifuged fluid is supplied is directed to produce spray or mist in lubricating relation to the high-speed bearing.

15. The combination of claim 4 including a second high-speed bearing located between an upper-portion of the shaft and said tubular member, said bearings being isolated from contact with fluid supplied to the centrifuge chamber.
